(19) United States
(12) Patent Application Publication
(10) Pub. No.: US 2004/0084193 A1
(43) Pub. Date: May 6, 2004

(54) Automatic anti-fire apparatus for vehicles

(76) Inventor: Jing Shiong Tseng, Chang Hua (TW)

Correspondence Address: Charles e. Baxley, esq., 90 John street, 3rd floor, New York, NY, 10038, US

(21) Appl. No.: 10/287,162

(22) Filed: Nov. 1, 2002

(51) Int. Cl. A62C 37/10

(52) U.S. Cl. 169/62; 169/60; 169/61

(57) ABSTRACT

An anti-fire apparatus for vehicle includes a control device coupled to a fire extinguishing device for actuating the fire extinguishing device, and a detector device coupled to the control device for operating the control device to actuate the fire extinguishing device. A device may include one or more batteries for energizing the detector device. A manual switch may be used to actuate the fire extinguishing device manually. The detector device includes a detector for detecting a vehicle collision, a fuel level and/or a fuel pressure and/or an engine temperature.

### BACKGROUND OF THE INVENTION

1. Field of the Invention

The present invention relates to an anti-fire apparatus, and more particularly to an automatic anti-fire apparatus for vehicles.

2. Description of the Prior Art

Various kinds of typical anti-fire devices have been developed for distinguishing fires of vehicles. Normally, the flammable liquid, e.g., gasoline, light oil or the like which is stored in the fuel tanks and/or the manifolds may flow out of the fuel tanks and/or the manifolds and may be caused by an accident such as a vehicle collision, roll-over or the like.

U.S. Pat. No. 4,194,588 to Wygal et al., U.S. Pat. No. 4,413,702 to Schlanger, and U.S. Pat. No. 5,559,699 to Gioutsos disclose three typical devices for vehicles that may be triggered by detecting the crash of vehicles.

U.S. Pat. No. 5,590,718 to Bertossi discloses a further anti-fire system for vehicles and includes a fire extinguisher supplying a fire extinguishing substance through a nozzle to discharge the fire extinguishing substance, and a valve controlled by at least one impact sensor which opens the valve when a collision of the vehicle with another object is detected by the sensor.

U.S. Pat. No. 4,533,801 to Jackman et al. discloses an inertia switch device having an inertia mass moved from a rest position as a result of acceleration or deceleration in excess of a given threshold value, in order to cause movable electrical contacts to engage or separate from further electrical contacts. The electric circuits may also be connected or caused by an accident such as a vehicle collision, roll-over or the like.

U.S. Pat. No. 5,531,290 to Furuichi et al. discloses a safety apparatus including a gelling agent tank for storing a gelling agent which can gelatinize the fuel received in the fuel tank, and a control system for outputting a drive signal while an emergency detection signal indicating an emergency in the fuel tank has been detected. However, the fuel in the manifolds may not be protected by the safety apparatus.

U.S. Pat. No. 5,614,280 to Hanna discloses a shielding blanket including a bag constructed of a lamination of materials including several plies of a high-strength ballistic textile material laminate, for fitting closely over the cylinder block and oil pan of the engine, and between the block and the exhaust headers. Two pads may prevent oil from escaping through either the engine block or the oil pan from reaching the exhaust headers.

However, the typical anti-fire devices for vehicles may all be initiated or triggered when a vehicle collision is detected; and may not be actuated when the other emergency conditions are occurred. Some times, no fire may be occurred even when a car accident or a vehicle collision has been found or happened. In addition, in the other circumstances, a fire may be occurred even when no car accident or vehicle collision has been found or happened.

The present invention has arisen to mitigate and/or obviate the afore-described disadvantages of the conventional anti-fire devices.

### SUMMARY OF THE INVENTION

The primary objective of the present invention is to provide an anti-fire apparatus for actuating one or more fire extinguishing devices by either detecting a vehicle collision, a high temperature, or an unusual fuel pressure or level.

In accordance with one aspect of the invention, there is provided an anti-fire apparatus for vehicle, the anti-fire apparatus comprising a fire extinguishing device, a control device coupled to the fire extinguishing device, for actuating the fire extinguishing device, a detector assembly coupled to the control device, for operating the control device to actuate the fire extinguishing device, and means for energizing the detector assembly.

The energizing means includes a primary battery, and a secondary battery coupled to the primary battery for energizing the vehicle in addition to the primary battery.

A manual switch may further be provided and coupled to the fire extinguishing device, for actuating the fire extinguishing device manually.

The control device includes a first relay and a second relay coupled to the fire extinguishing device for actuating the fire extinguishing device automatically.

The control device includes a delay device coupled to the first and the second relays for time delaying purposes.

The control device includes a switch coupled to the first relay for switching off electric power of the vehicle.

The detector assembly includes a detector for detecting a vehicle collision, another detector for detecting a fuel level and/or for detecting a fuel pressure and/or for detecting an engine temperature.

The detector assembly may include another detector for detecting a warning temperature to actuate the fire extinguishing device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram of an anti-fire apparatus in accordance with the present invention;

FIG. 2 is a schematic view illustrating a circuit of the anti-fire apparatus;

FIG. 3 is a partial exploded view illustrating a collision detecting device of the anti-fire apparatus;

FIGS. 4, 5 are partial cross sectional views illustrating the operation of the collision detecting device as shown in FIG. 3;

FIG. 6 is a block diagram illustrating the detailed structure of the anti-fire apparatus;

FIG. 7 is a block diagram illustrating the detailed structure of the fuel pressure detecting system for the anti-fire apparatus;

FIG. 8 is a plan schematic view illustrating the fuel system for the vehicle;

FIG. 9 is a schematic view illustrating a portion of the circuit of the anti-fire apparatus, for detecting the fuel pressure, the engine temperature, and the fuel level;

FIG. 10 is a further block diagram illustrating the detailed structure of the high temperature detecting system for the anti-fire apparatus;

FIG. 11 is another schematic view illustrating another portion of the circuit of the anti-fire apparatus for detecting the vehicle collision; and

FIG. 12 is a further schematic view illustrating a further portion of the circuit of the anti-fire apparatus for actuating the fire extinguishing device by high temperature.

### DETAILED DESCRIPTION OF THE PREFERRED EMBODIMENT

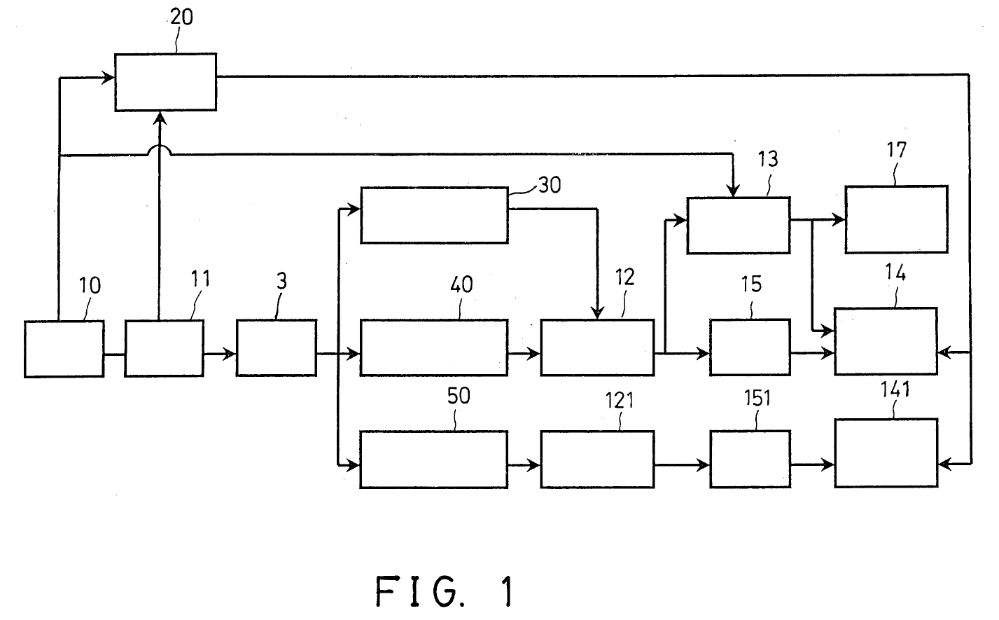

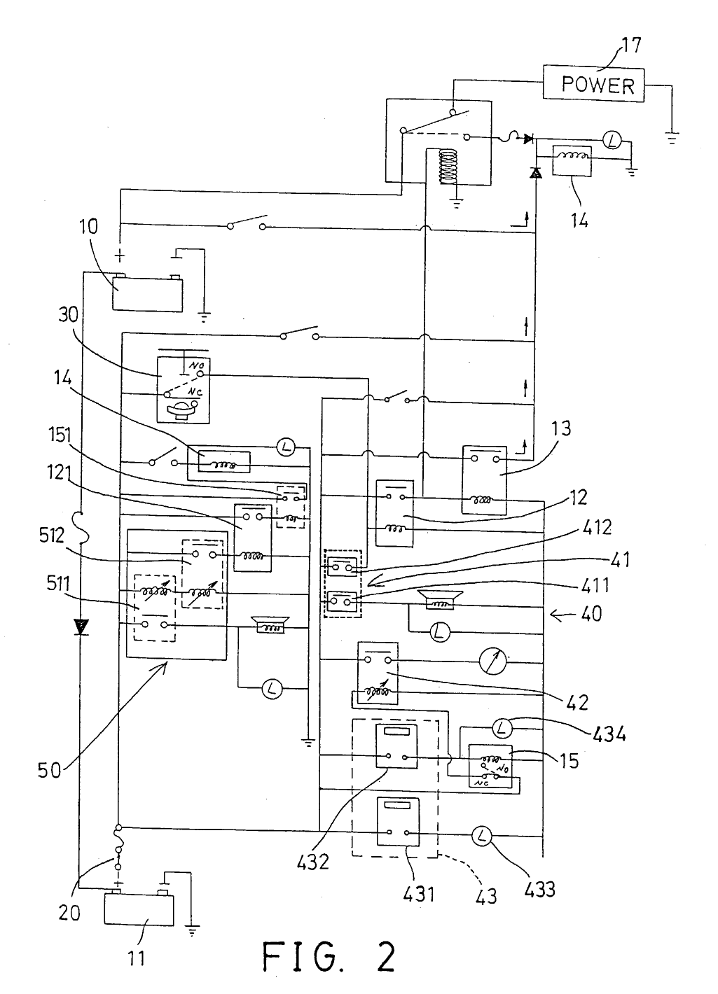

Referring to the drawings, and initially to FIGS. 1 and 2, an anti-fire apparatus in accordance with the present invention comprises a first or a primary battery 10, such as the battery of the vehicle, and a second or a secondary battery 11 coupled between the first battery 10 and a detector assembly 3. The batteries 10, 11 are both coupled to a switch, such as a manual switch 20.

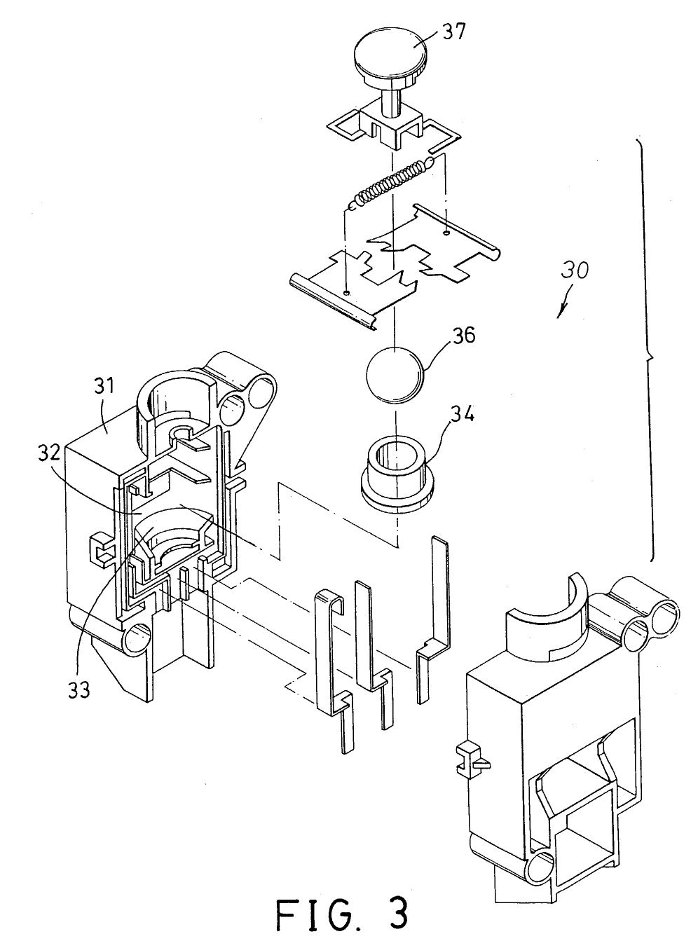

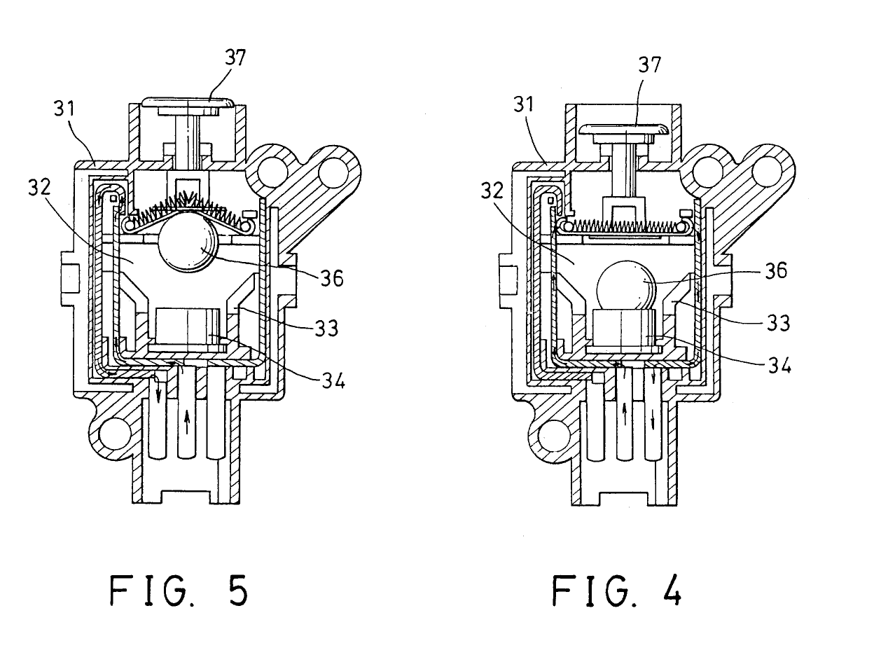

The detector assembly 3 includes a first detector 30, such as an inertia switch device 30 as shown in FIGS. 3-5, for detecting such as a vehicle collision; a second detector 40 for detecting the engine temperature and/or the fuel level and/or the fuel pressure; and a third detector 50 for detecting the high temperature in the other portion of the vehicle.

The first and the second detectors 30, 40 are both coupled to a delay device, such as a time delay device 12 which is then coupled to two control devices, such as relays 13, 15. The control devices 13, 15 may also be the integrated circuits, the processor units, or the likes and coupled to a fire extinguishing device 14.

For example, the first or the primary relay 13 may be used to switch off the electric system of the vehicle by such as a power 17 or the like, and to actuate the fire extinguishing device 14. The secondary control device or relay 15 may only be used to actuate the fire extinguishing device 14, and may not be used to switch off the electric system of the vehicle.

Referring next to FIGS. 3-5, the inertia switch device or the first detector 30 includes a housing 31 having a chamber 32 formed therein for receiving a funnel 33 therein, a magnet member 34 disposed in the bottom of the funnel 33, an inertia mass 36 received in the funnel 33 and movable from a rest position as a result of acceleration or deceleration in excess of a given threshold value.

For example, the inertia mass 36 may be forced or caused or actuated to engage or separate from an electrical and spring-biased switch 37 when the inertia mass 36 is moved from the rest position and caused by an accident such as a vehicle collision, roll-over or the like.

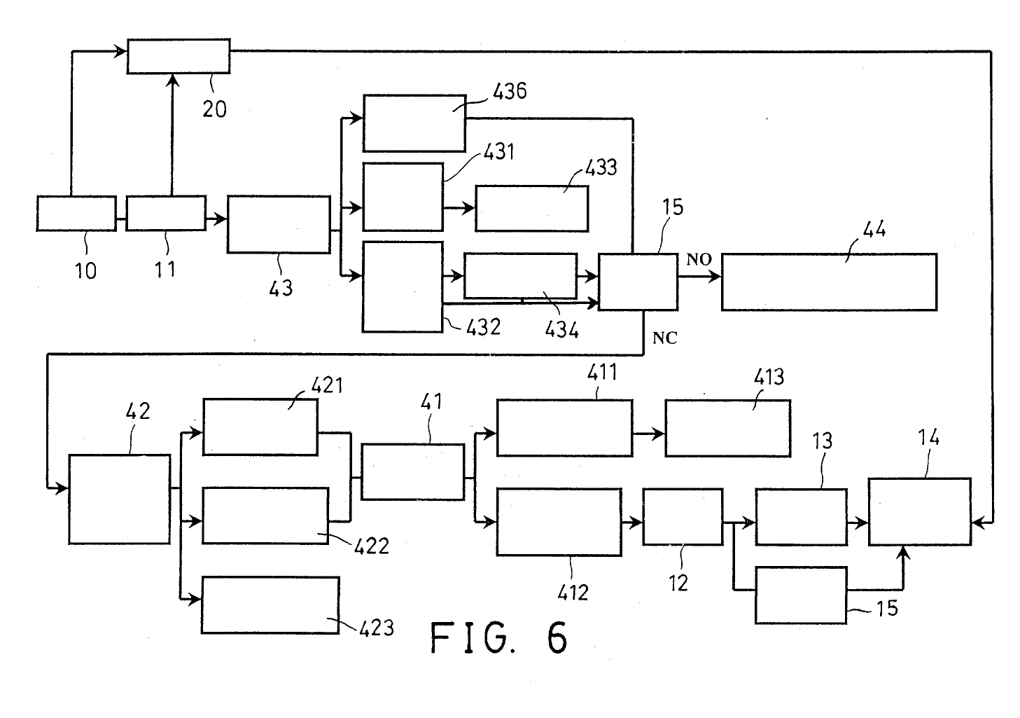

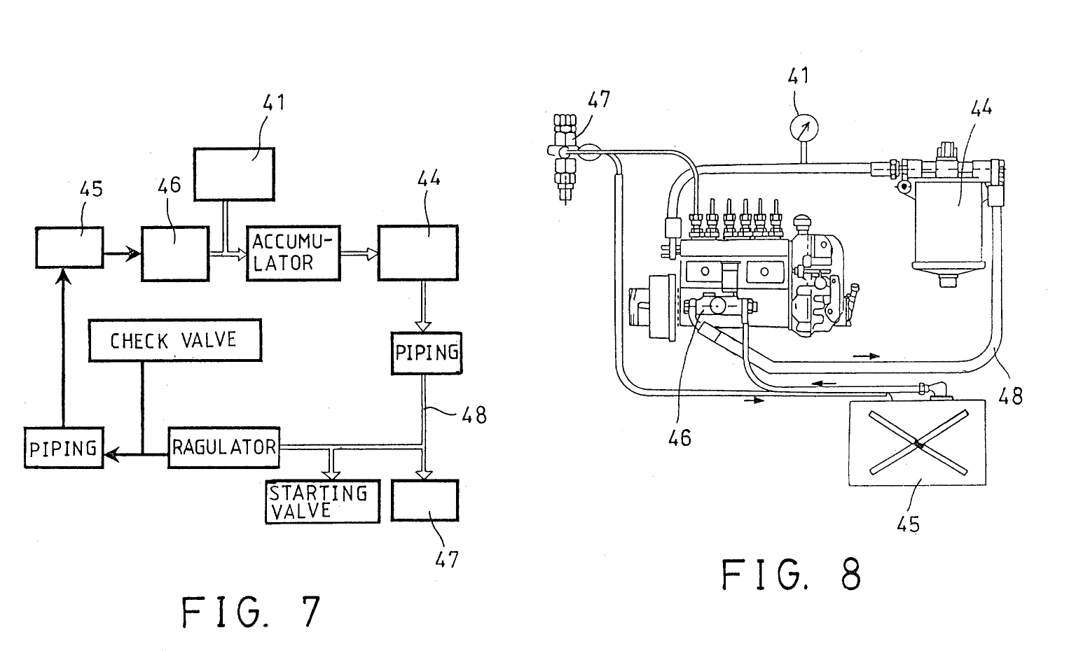

Referring next to FIGS. 6-8, the second detector 40 includes a pressure gauge 41 for detecting the fuel pressure in the fuel tank 45 and in the manifolds 48. For example, as shown in FIG. 7, a gas or gasoline engine is illustrated and includes a filter 44, and a pump 46 for pumping the fuel or the gasoline from the fuel tank 45 to or through the filter 44, and to a fuel injection nozzle or device 47.

Similarly, as shown in FIG. 8, a diesel engine is illustrated and also includes a filter 44, and a pump 46 for pumping the fuel or the gasoline from the fuel tank 45 to or through the filter 44, and to a fuel injection nozzle or device 47. The pressure gauge 41 is normally coupled between the pump 46 and the filter 44 for detecting the fuel pressure in the fuel tank 45 and/or in the manifolds 48.

As shown in FIG. 6, the pressure gauge 41 of the second detector 40 may detect a pressure that is lower than a predetermined low pressure in the fuel system, such as lower than 2.0 kg/cm², while running idle or idling of the engine, at process 411. For example, when the pressure is lower than 1.8 kg/cm² for a gasoline engine, or 1.35 kg/cm² for a diesel engine, a warning device 413 may generate a warning light or a sound or the other warning signals.

When the pressure gauge 41 of the second detector 40 detects a pressure that is lower than a predetermined lowest or minimum pressure in the fuel system, such as lower than 0.2 kg/cm², at process 412, the delay device, such as the time delay device 12 may then be operated to actuate the fire extinguishing device 14 via either of the relays 13, 15, to extinguish the fires that may have been occurred.

In addition to the pressure gauge 41, the second detector 40 further includes a level gauge 43 coupled to the secondary battery 11, for typically detecting the predetermined low fuel level in the fuel tank 45, in the process 431 of FIG. 6. Another warning device 433 may be used to generate a warning light or a sound or the other warning signals when the predetermined low fuel level in the fuel tank 45 has been detected.

In addition, the level gauge 43 may further be used to detect the lowest fuel level or to detect when the fuel tank 45 is empty at process 432 (FIG. 6), which has a fuel level even lower than the predetermined low fuel level in the fuel tank 45.

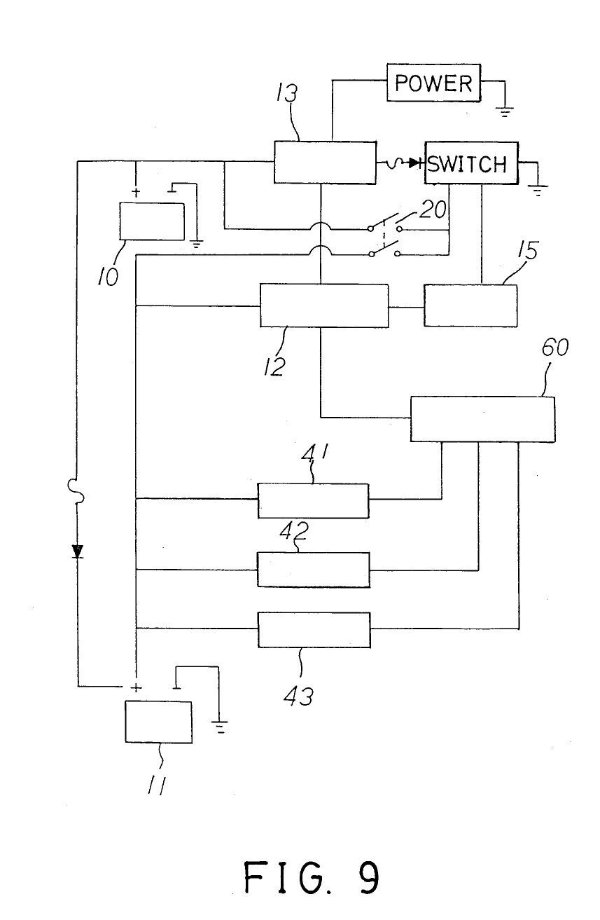

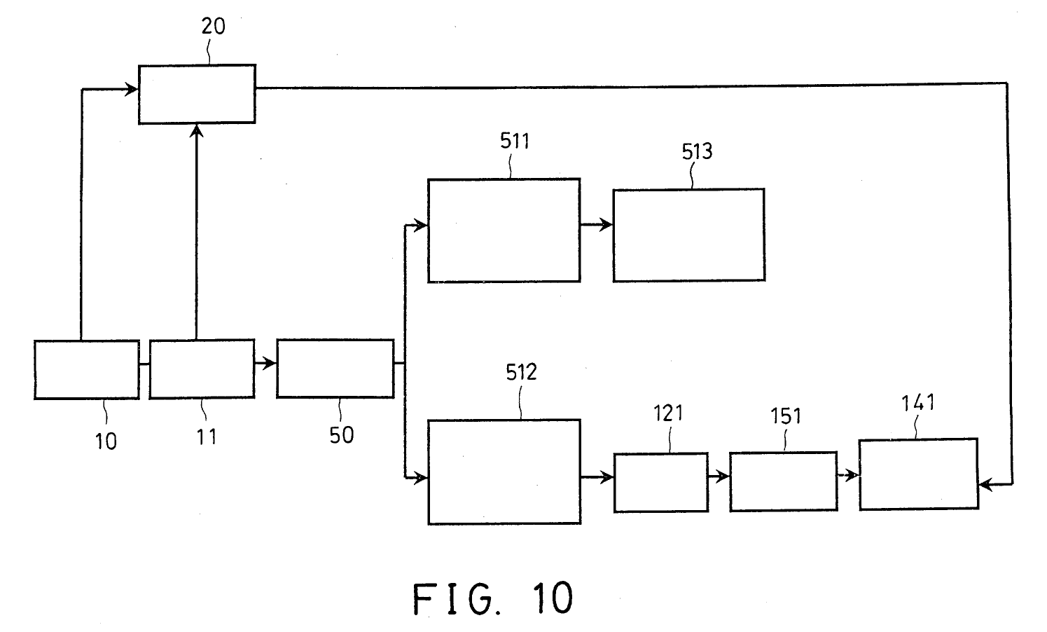

A further warning device 434 may be used to generate a warning light or a sound or the other warning signals, and the relay 15 or the processor or control device 60 as shown in FIG. 9 may be actuated to switch off the electric power to the second detector 40 at process 44, when the lowest fuel level in the fuel tank 45 has been detected.

It is to be noted that a pressure which is lower than the predetermined lowest or minimum pressure in the fuel system, or in the tank 45 and in the manifolds 48, such as lower than 0.2 kg/cm², may be detected by the pressure gauge 41 when the lowest fuel level in the fuel tank 45 has been detected. At this moment, the electric power to the second detector 40 is switched off at process 44 for preventing the fire extinguishing device 14 from being actuated via the relays 13, 15.

When the fuel level in the fuel tank 45 is smaller than the predetermined low fuel level and is detected by the level gauge 43 at process 432, the relay 15 may also be actuated to switch off the electric power to the second detector 40 at process 44, for preventing the fire extinguishing device 14 from being actuated via the relays 13, 15.

The second detector 40 further includes a thermometer 42 coupled to the relay 15. The thermometer 42 may be a thermocouple which may detect a temperature from 0 to 2300° C., or a thermistor which may detect a temperature from −200 to 750° C. The thermometer 42 is provided for detecting the temperature around the exhaust pipe of the vehicle.

When the thermometer 42 detects a temperature of the exhaust pipe that is greater than 200° C., at process 421 of FIG. 6, a control signal may be sent to the pressure gauge 41 and/or the relay 15 and/or the processor or control device 60 (FIG. 9), for judging or determining whether the fire extinguishing device 14 is to be actuated or not.

The thermometer 42 or another thermometer 42 may further be disposed close to the engine, to detect the temperature in the engine room or close to the engine. For example, when the thermometer 42 detects a temperature around the engine that is about 45-65° C., at process 422 of FIG. 6, a control signal may be sent to the pressure gauge 41 and/or the relay 15 or 13 and/or the processor or control device 60 (FIG. 9), for judging or determining whether the fire extinguishing device 14 is to be actuated or not.

Normally, when the temperature around the engine reaches about 45-65° C., the temperature around the exhaust pipe may reach up to 200° C. The temperature around the engine may reach up to 650° C. for a gasoline engine, and up to 500° C. for a diesel engine. The ignition point of gasoline is normally about 280-456° C., and the ignition point of diesel oil is more than 300° C.

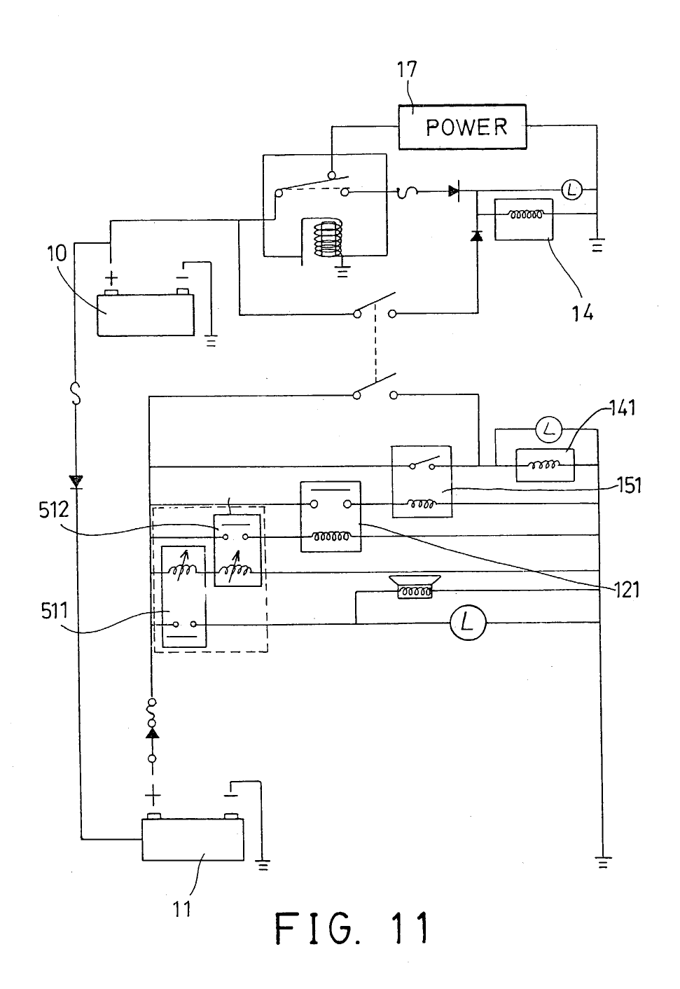

The fire extinguishing device 14 may be actuated or operated when the control signal has been sent to the pressure gauge 41 and/or the relay 15 and/or the processor or control device 60 (FIG. 11), and simultaneously when the level gauge 43 has detected the lowest fuel level or the emptiness of the fuel tank 45 at process 432 of FIG. 6.

When the temperature around the engine has been detected to be lower than 45° C., or when the temperature of the exhaust pipe has been detected to be lower than 200° C., at process 423 of FIG. 6, no control signals will be sent to the pressure gauge 41 and/or the relay 15 and/or the processor or control device 60 (FIG. 11), such that the fire extinguishing device 14 will not be actuated at this moment.

Referring next to FIGS. 10, 11, and again to FIGS. 1 and 2, the third detector 50 is coupled to the secondary battery 11, and may be used to detect the flame, the smoke, and/or the heat. Particularly, the third detector 50 preferably one or more thermometers for detecting the temperatures around the engine and/or in various portions of the vehicle.

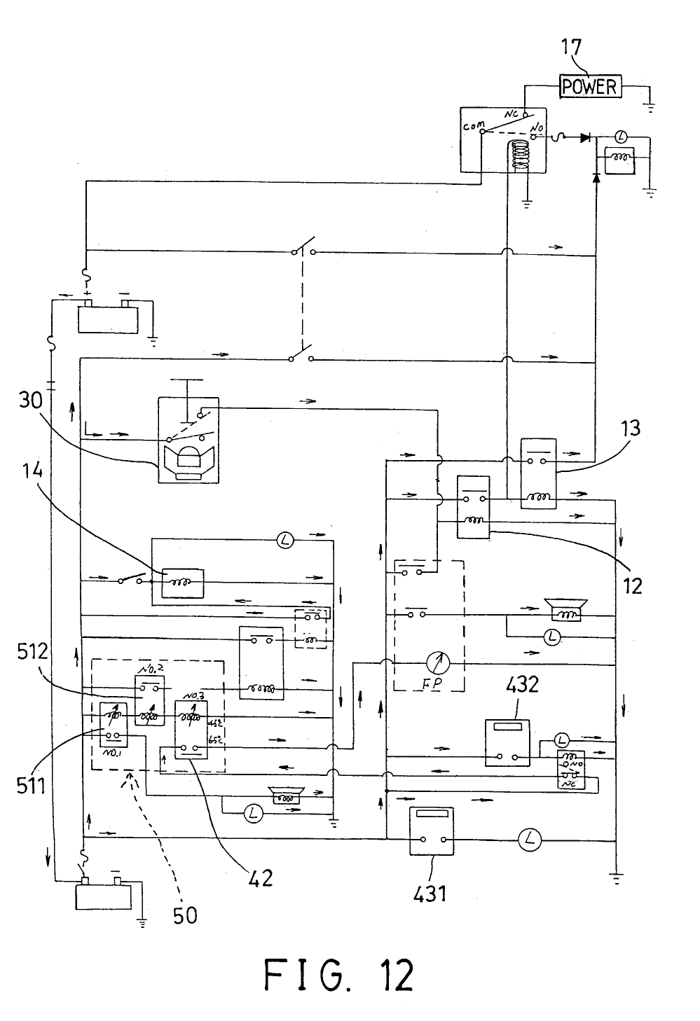

For example, the third detector 50 includes one or more first and a second thermometers 511, 512. When the first thermometer 511 (FIG. 11) or when either of the first thermometers 511 (FIG. 12) detects a temperature such as 10° C. greater than the normal or average temperature around the engine, a warning device 513 may be used to generate a warning light or a sound or the other warning signals.

When the second thermometer 512 detects a temperature such as 6 to 10° C. greater than the predetermined greatest endurable temperature around the engine, or when the environment around the engine reaches a temperature such as 6 to 10° C. greater than the predetermined warning temperature, the other fire extinguishing device 141 may be actuated or operated by the other delay device 121 and/or the other relay 151.

Alternatively, the third detector 50 may also be coupled to the fire extinguishing device 14 via the delay device 12 and/or either of the relays 13, 15, for allowing the fire extinguishing device 14 and the delay device 12 and/or either of the relays 13, 15 to be actuated or operated by the third detector 50.

It is to be noted that the electric power of the vehicle may be switched off by the power 17 only by the relay 13, as shown in FIG. 1. Accordingly, the vehicle may still be energized when a high temperature around the engine or in the vehicle has been detected by the third detector 50. This may prevent the vehicle from being lost control.

The anti-fire apparatus further includes a manual switch 20 for actuating or operating either or both the fire extinguishing devices 14, 141 when required.

The provision of the secondary battery 11 is for energizing the vehicle when the primary battery 10 is out of order or is shorted or is damaged, or for energizing the vehicle in addition to the primary battery 10.

In operation, as shown in FIGS. 1 and 2, when an accident such as a vehicle collision, roll-over or the like is happened, the first detector 30 or the inertia switch device 30 may be used for detecting such as the vehicle collision, and then for switching off the electric power of the vehicle and for actuating the fire extinguishing device 14.

The second detector 40 may also be used to switch off the electric power of the vehicle and/or to actuate the fire extinguishing device 14 when a low fuel lever and/or a low fuel pressure and/or a high temperature around the engine has been detected.

The third detector 50 may be used to actuate the other fire extinguishing device 141 when a high temperature has been detected around the engine or in various portions of the vehicle. The fire occurred by the causes other than the vehicle collisions may also be detected and may be distinguished by either or both of the fire extinguishing devices 14, 141 via the detectors 40, 50 and the relays 15, 151.

Accordingly, the anti-fire apparatus in accordance with the present invention may be used for actuating one or more fire extinguishing devices by either detecting a vehicle collision, a high temperature, or an unusual fuel pressure or level.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An anti-fire apparatus for vehicle, said anti-fire apparatus comprising:
a fire extinguishing device, a control device coupled to said fire extinguishing device, for actuating said fire extinguishing device,
a detector assembly coupled to said control device, for operating said control device to actuate said fire extinguishing device, and
means for energizing said detector assembly.

2. The anti-fire apparatus according to claim 1, wherein said energizing means includes a primary battery, and a secondary battery coupled to said primary battery for energizing the vehicle in addition to said primary battery.

3. The anti-fire apparatus according to claim 1 further comprising a manual switch coupled to said fire extinguishing device, for actuating said fire extinguishing device manually.

4. The anti-fire apparatus according to claim 1, wherein said control device includes a first relay and a second relay coupled to said fire extinguishing device.

5. The anti-fire apparatus according to claim 4, wherein said control device includes a delay device coupled to said first and said second relays.

6. The anti-fire apparatus according to claim 4, wherein said control device includes a switch coupled to said first relay for switching off electric power of the vehicle.

7. The anti-fire apparatus according to claim 1, wherein said detector assembly includes a detector for detecting a vehicle collision.

8. The anti-fire apparatus according to claim 1, wherein said detector assembly includes a detector for detecting a fuel level.

9. The anti-fire apparatus according to claim 8, wherein said said detector of said detector assembly is used for detecting a fuel pressure.

10. The anti-fire apparatus according to claim 8, wherein said said detector of said detector assembly is used for detecting an engine temperature.

11. The anti-fire apparatus according to claim 1, wherein said detector assembly includes a detector for detecting a warning temperature to actuate said fire extinguishing device.
